(19) United States
(12) Patent Application Publication
(10) Pub. No.: US 2010/0252552 A1
(43) Pub. Date: Oct. 7, 2010

(54) Adjustable Depth Electrical Components

(76) Inventors: David Nikayin, Los Angeles, CA (US); Benjamin G. Tuazon, Los Angeles, CA (US); Saeid Katal, Los Angeles, CA (US); Afshin Jafari, Los Angeles, CA (US)

Correspondence Address: CROCKETT & CROCKETT, P.C., 26020 ACERO, SUITE 200, MISSION VIEJO, CA, 92691, US

(21) Appl. No.: 12/577,591

(22) Filed: Oct. 12, 2009

Related U.S. Application Data
(60) Provisional application No. 61/104,484, filed on Oct. 10, 2008.
(60) Provisional application No. 61/145,427, filed on Jan. 16, 2009.

(51) Int. Cl. H02G 3/08

(52) U.S. Cl. 220/3.7

(57) ABSTRACT

A ratchet bracket electrical box includes ratchet locking plates and adjustment spring arms secured to the sides of an electrical box or other suitable component to enable the position of the electrical box or component to be adjusted after the electrical box is secured within a wall, floor or ceiling. Using spring arms and unlocking tabs enables the box position to be adjusted without any tools after installation.

### RELATED APPLICATIONS

This application claims priority from copending U.S. Provisional patent application 61/104,484 filed Oct. 10, 2008 and copending U.S. Provisional patent application 61/145,427 filed Jan. 16, 2009.

### FIELD OF THE INVENTIONS

The inventions described below relates to the field of electrical construction components and more specifically to electrical components for mounting within a structural diaphragm capable of depth adjustment after mounting within the diaphragm.

### BACKGROUND OF THE INVENTIONS

Conventional electrical construction techniques secure electrical components to metal or wood studs. This technique provides little flexibility to adjust the component position vertically, horizontally or depth within a wall, floor or ceiling after the component is originally secured.

### SUMMARY

An adjustable depth electrical component such as a box or a plaster ring includes ratchet locking plates and adjustment spring arms secured to the sides of an electrical box or plaster ring to enable the depth of the box or ring to be adjusted after the electrical component is secured to the structural elements within a wall, ceiling or floor. Using spring arms enables the components depth position relative to the surface plane of a structural diaphragm such as a wall, ceiling or floor to be adjusted without any tools after the attachment flange is secured to a structural component such as a stud, joist or other element of a structural diaphragm.

### BRIEF DESCRIPTION OF THE DRAWINGS

FIG. 1 is an isometric view of a depth adjustable electrical box with sliding lock brackets.

FIG. 2 is an isometric view of the electrical box of FIG. 1 installed in a wall.

FIG. 3 is a top view of the electrical box of FIG. 1.

FIG. 4 is a back view of the electrical box of FIG. 1.

FIG. 5 is a cutaway top view of the electrical box of FIG. 4 taken along line A-A.

FIG. 6 is a top view of the springs for adjustably securing the electrical box of FIG. 1.

FIG. 7A is an isometric view of a depth adjustable plaster frame.

FIG. 7B is an isometric view of a ratchet spring for the depth adjustable plaster frame of FIG. 7A.

FIG. 7C is an front view of an attachment flange for the depth adjustable plaster frame of FIG. 7A.

FIG. 8 is an front view of a depth adjustable plaster ring.

FIG. 9 is a top view of the depth adjustable plaster ring of FIG. 8.

FIG. 10 is a side view of the depth adjustable plaster ring of FIG. 8.

FIG. 11A is a cross-section view of the depth adjustable plaster ring of FIG. 8 taken along B-B.

FIG. 11B is a close-up view of the ratchet engagement of the depth adjustable plaster ring of FIG. 11A.

FIG. 12 is an isometric view of the depth adjustable plaster ring of FIG. 8.

FIG. 13 is an isometric view of a ratchet bracket plaster ring.

FIG. 14 is an exploded isometric view of the ratchet bracket plaster ring of FIG. 13.

FIG. 15A is a front view of the ratchet bracket plaster ring of FIG. 13.

FIG. 15B is a close-up view of the engagement elements of the ratchet bracket plaster ring of FIG. 13 taken along C-C.

FIG. 16 is a top view of the ratchet bracket plaster ring of FIG. 13.

FIG. 17 is a side view of the ratchet bracket plaster ring of FIG. 13.

FIG. 18 is a front view of an alternate ratchet bracket plaster ring.

FIG. 19A is a side view of the engagement spring for the ratchet bracket plaster rings of FIGS. 13 and 18.

FIG. 19B is a top view of the engagement spring of FIG. 19A.

FIG. 19C is an isometric view of the engagement spring of FIG. 19A.

FIG. 20 is a front view of a depth adjustable plaster ring.

FIG. 21 is a side view of the depth adjustable plaster ring of FIG. 20.

FIG. 22 is a top view of the depth adjustable plaster ring of FIG. 20.

FIG. 23A is a cross-section view of the engagement elements of the depth adjustable plaster ring of FIG. 20 taken along D-D.

FIG. 23B is a close-up view of the engagement elements of the depth adjustable plaster ring of FIG. 23A.

FIG. 24 is an isometric view of the depth adjustable plaster ring of FIG. 20.

FIG. 25A is a front view of a depth adjustable plaster ring.

FIG. 25B is a cross-section view of the engagement elements of the depth adjustable plaster ring of FIG. 25A taken along E-E.

FIG. 26 is a side view of the depth adjustable plaster ring of FIG. 25A.

FIG. 27 is a top view of the depth adjustable plaster ring of FIG. 25A.

FIG. 28 is an vertically oriented isometric view of the depth adjustable plaster ring of FIG. 25A.

FIG. 29 is an horizontally oriented isometric view of the depth adjustable plaster ring of FIG. 25A.

FIG. 30A is a front view of a depth adjustable plaster ring with a screw lock.

FIG. 30B is a close up view of the screw lock retainer of the depth adjustable plaster ring FIG. 30A.

FIG. 31 is a side view of the depth adjustable plaster ring with a screw lock of FIG. 30A.

FIG. 32 is a top view of the depth adjustable plaster ring with a screw lock of FIG. 30A.

FIG. 33A is a cross-section view of the depth adjustable plaster ring of FIG. 30A taken along F-F.

FIG. 33B is a cross-section view of the screw lock retainer of the depth adjustable plaster ring of FIG. 30A.

FIG. 34 is an isometric view of the depth adjustable plaster ring of FIG. 30A.

FIG. 35 is an isometric view of a plaster frame for the depth adjustable plaster ring of FIG. 30A.

FIG. 36A is a top view of a locking screw for the depth adjustable plaster ring of FIG. 30A.

FIG. 36B is an isometric view of a locking screw for the depth adjustable plaster ring of FIG. 30A.

FIG. 36C is a side view of a locking screw for the depth adjustable plaster ring of FIG. 30A.

FIG. 36D is a bottom view of a locking screw for the depth adjustable plaster ring of FIG. 30A.

FIG. 37 is an isometric exploded view of a depth adjustable electrical box with a ratchet bracket and biasing spring.

FIG. 38 is an end view of the electrical box of FIG. 37.

FIG. 39 is a front view of the electrical box of FIG. 37.

### DETAILED DESCRIPTION OF THE INVENTIONS

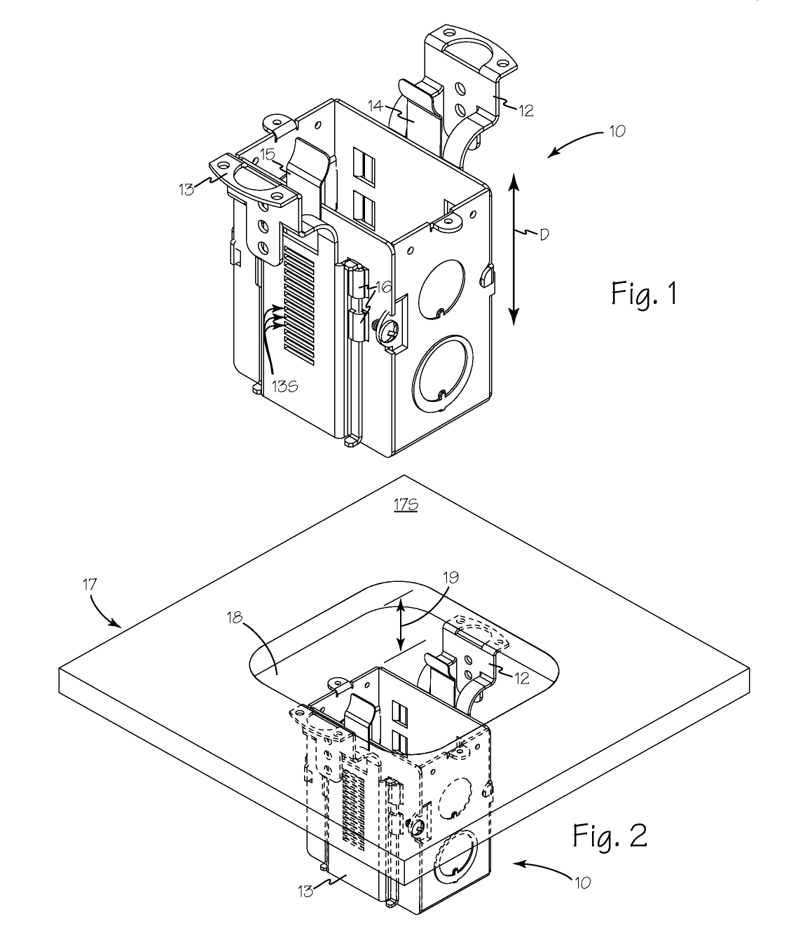

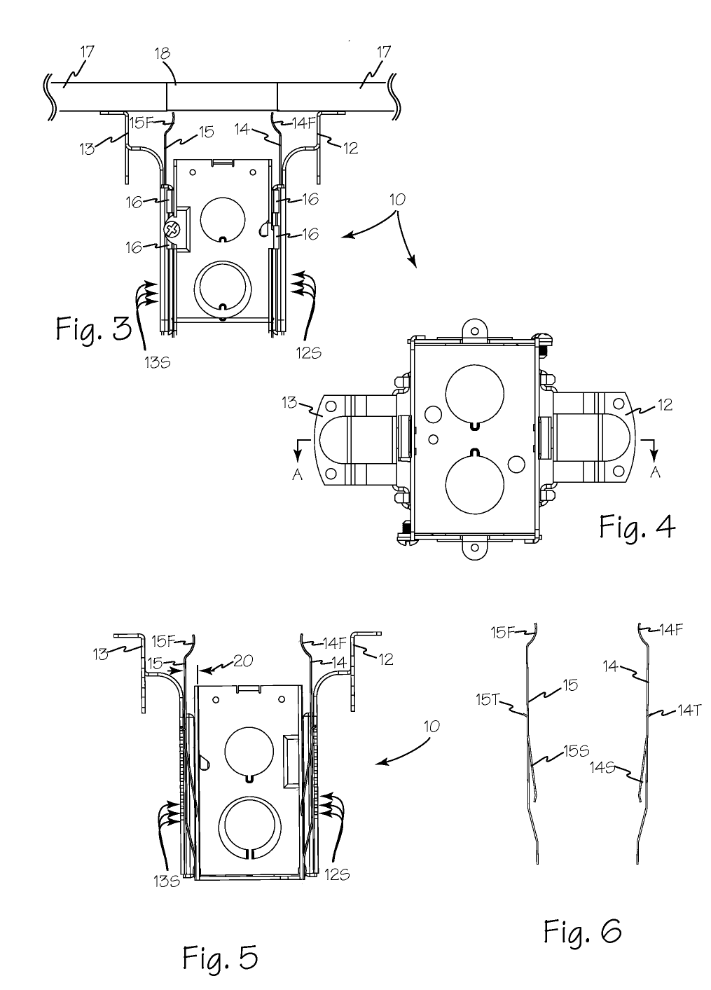

In FIGS. 1, 3, 4 and 5, adjustable depth electrical box 10 includes first and second mounting arms 12 and 13 which are slidably engaged to electrical box 10 using any suitable technique such as fingers 16. First and second spring locking arms 14 and 15 are secured to electrical box 10 and provide a biased locking element to engage locking slots such as locking slots 13S.

In use, electrical box 10 may be secured to any suitable structural element such as studs, joists, posts, wall panels or other elements such as gypsum board 17 as shown in FIG. 2. First and second mounting arms 12 and 13 are secured adjacent opening 18. Any depth adjustment of electrical box 10 that is desired after securing first and second mounting arms 12 and 13 to suitable structural elements may be accomplished through opening 18 by applying force to first and second spring locking arms 14 and 15 in opposition their biasing force and changing for example, depth 19 of electrical box 10 relative to surface plane 17S of gypsum board 17.

Referring now to FIG. 6, first and second spring locking arms 14 and 15 are shown with engagement teeth 14T and 15T visible. Offset fingers 14F and 15F enable a user to apply force to locking arms against the spring bias within opening 18.

Spring locking arms provide some spring bias to engage teeth 14T and 15T. Additional bias force may be provided by bias spring arms 14S and 15S.

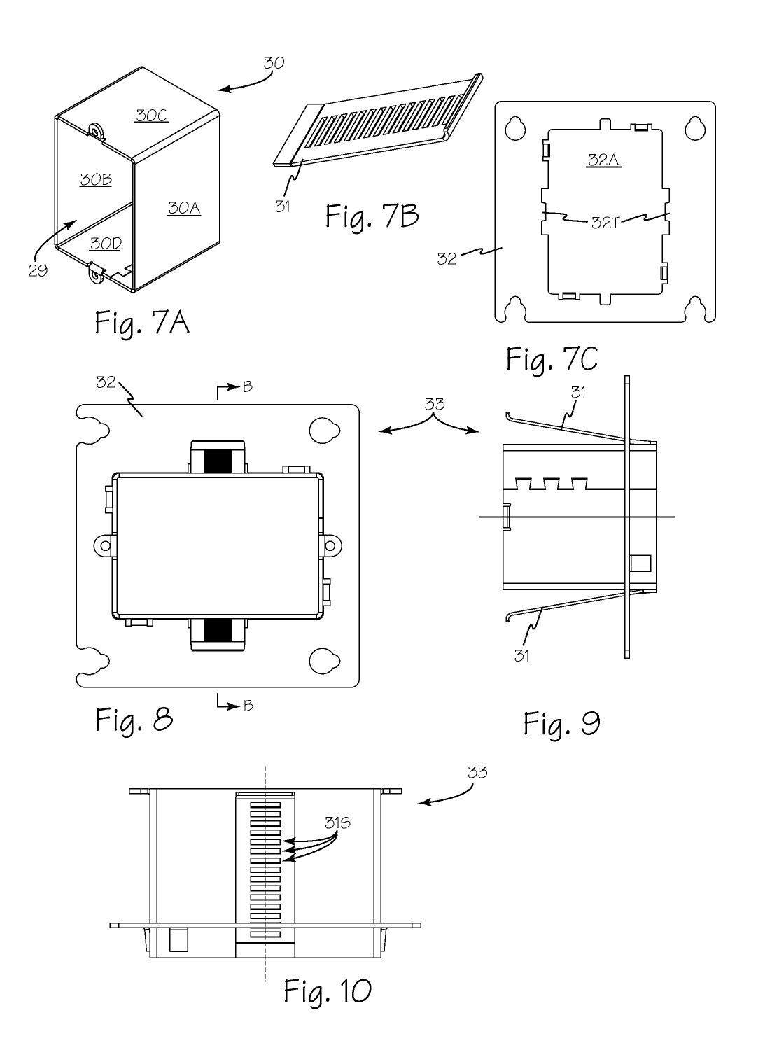

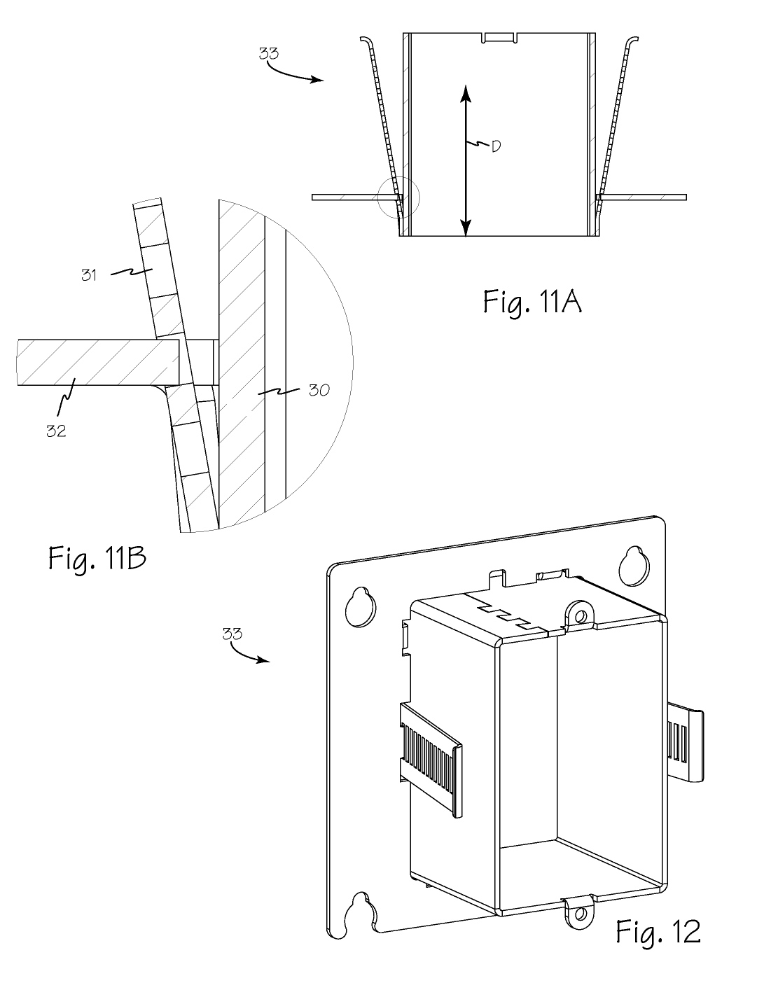

Referring now to FIGS. 7A, 7B, 7C, 8, 9, 10, 11A and 12; plaster frame 30 is formed of opposing sides 30A and 30B and opposing ends 30A and 30B enclosing working space 29. Plaster frame 30 also includes two or more slotted biasing springs such as slotted biasing spring 31 with a plurality of slots 31S for engaging teeth 32T on attachment flange 32. Attachment flange 32 includes opening 32A which is sized and dimensioned to slidably engage plaster frame 30. Depth adjustable plaster ring 33 includes attachment flange 32 engaging biasing springs 31 and plaster plaster frame 30.

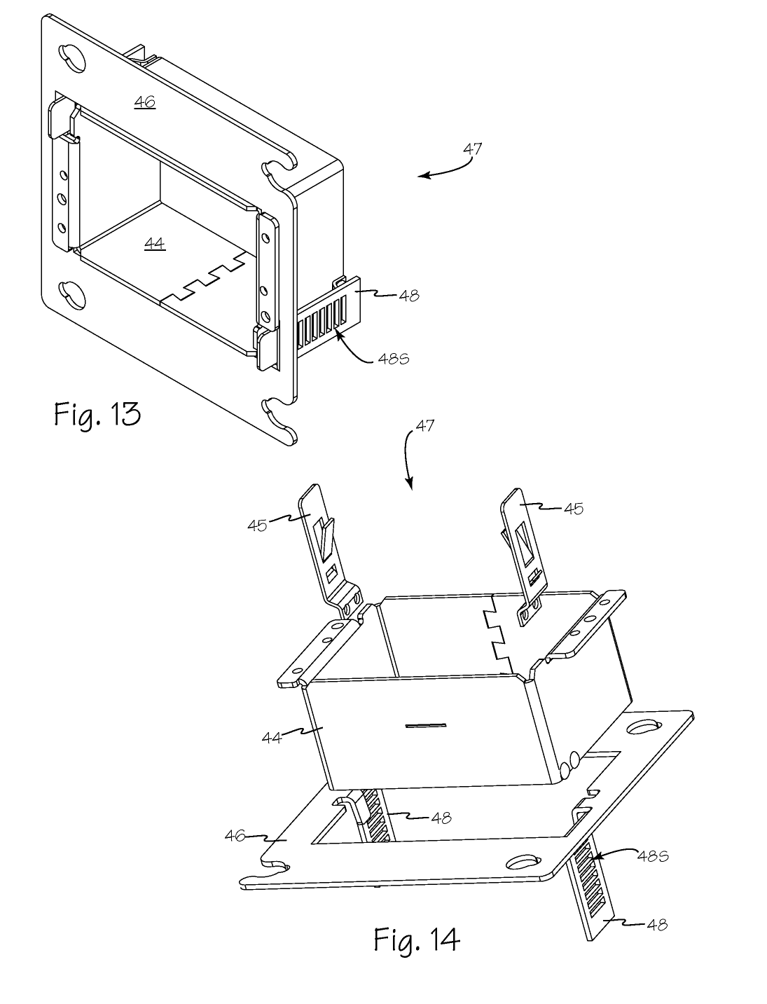

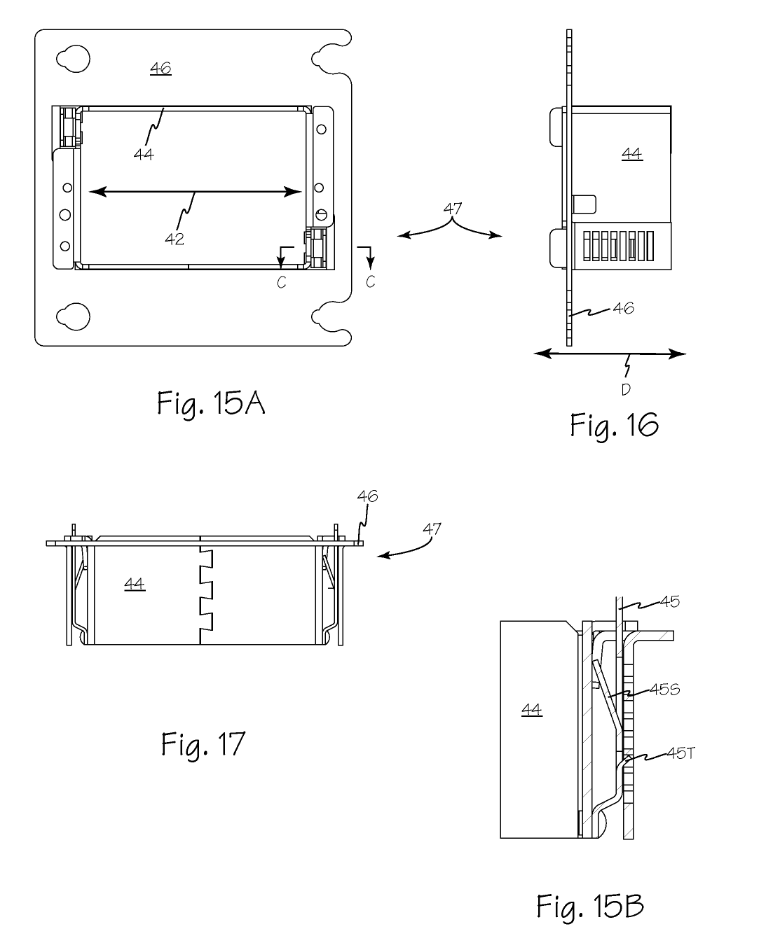

Referring now to FIGS. 13, 14, 15A, 16 and 17; plaster frame 44 and two or more locking spring arms such as locking spring arm 45 and attachment flange 46 with slotted arms 48 are combined to form a depth adjustable plaster ring such as depth adjustable plaster ring 47. Each locking spring arm includes at least one bias spring such as bias spring 45S and at least one engagement tooth such as tooth 45T for engaging any suitable slot 48S in slotted arm 48. Plaster frame 44 has a long axis 42 with the spring arms and bias springs operating parallel to long axis 42.

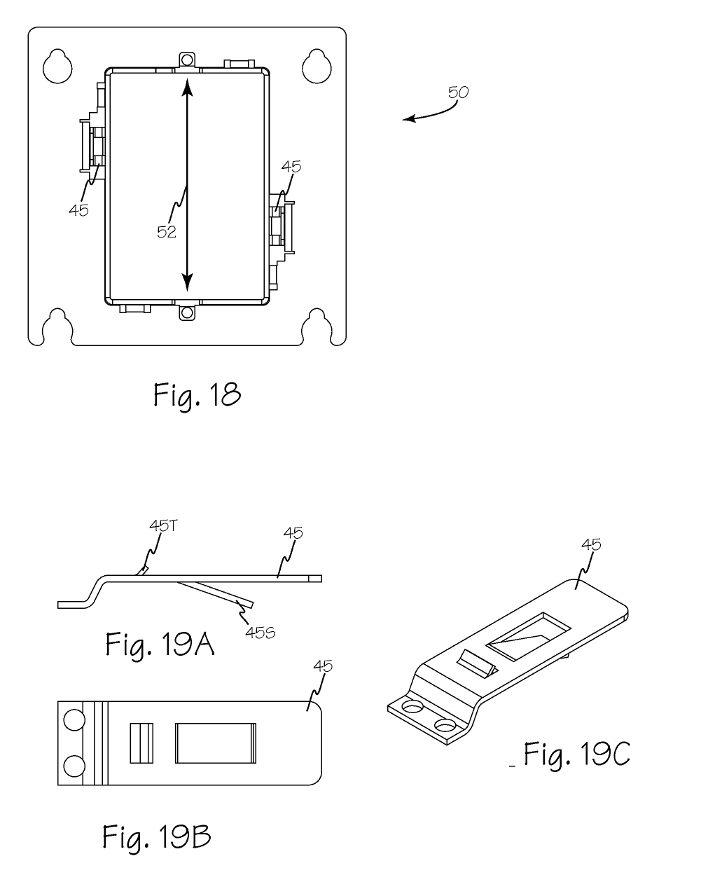

Referring now to FIG. 18, depth adjustable plaster ring 52 includes locking spring arm 45 which operates perpendicular to long axis 53. Similarly other depth adjustable components discussed may include depth adjustment and depth securing mechanisms in any suitable configuration relative to the orientation of the electrical box, plaster frame or other element.

Locking spring arm 45 is illustrated in FIGS. 19A, 19B and 19C showing bias spring 45S and engagement tooth 45T.

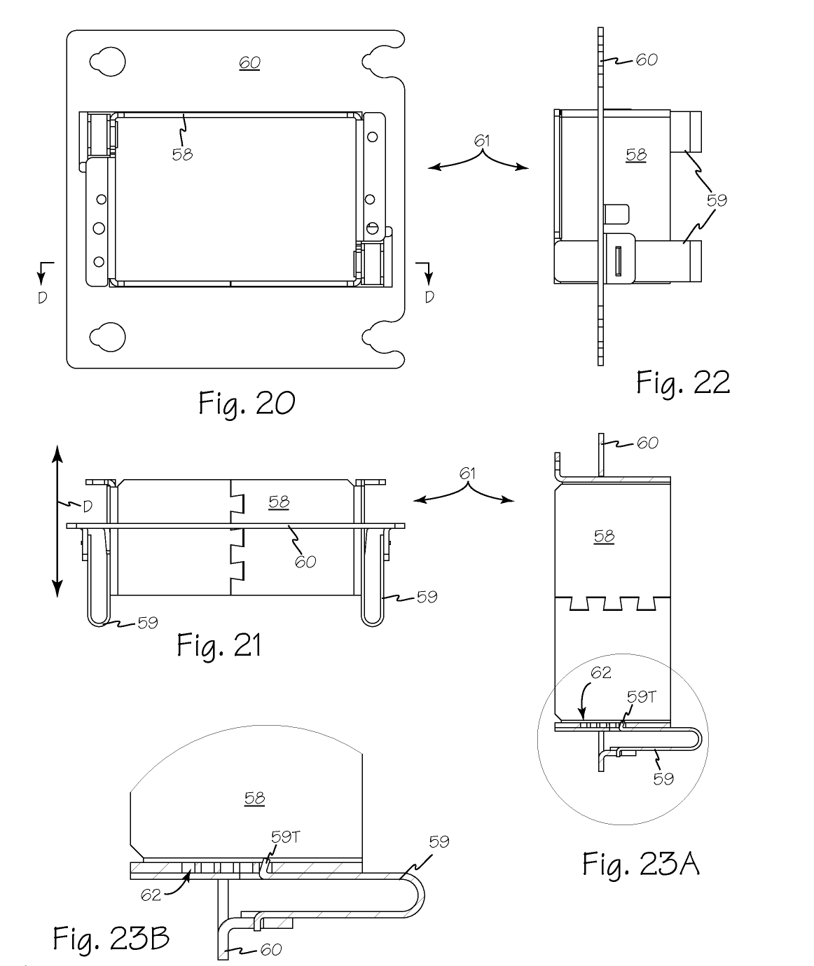

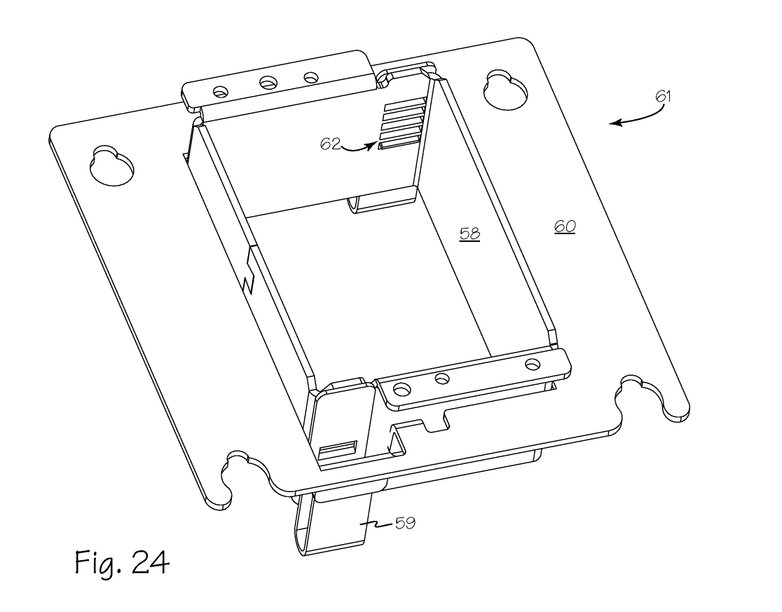

Referring now to FIGS. 20, 21, 22, 23A, 23B and 24; plaster frame 58 and two or more locking bias springs such as locking bias spring 59 and attachment flange 60 are combined to form a depth adjustable plaster ring such as depth adjustable plaster ring 61. Locking bias springs 59 are secured to attachment flange and a set of depth adjustment slots 62 are formed in plaster frame 58 to engage tooth 59T on the locking bias spring.

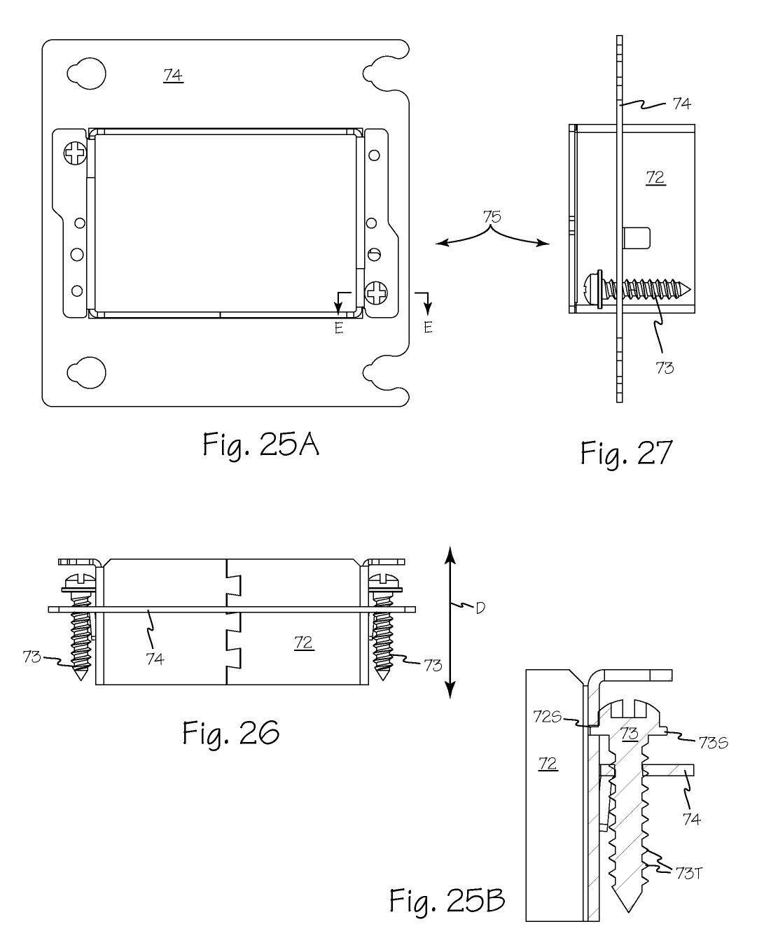

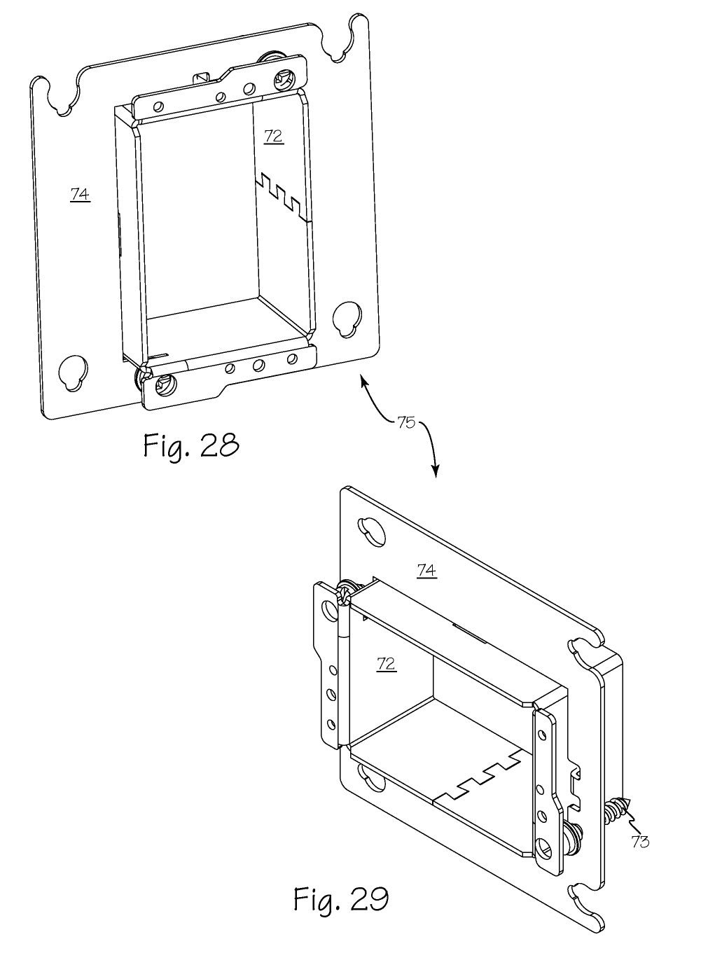

Referring now to FIGS. 25A, 25B, 26, 27, 28 and 29; plaster frame 72 and two or more adjustment screws such as adjustment screws 73 and attachment flange 74 are combined to form a depth adjustable plaster ring such as depth adjustable plaster ring 75. Each adjustment screw 73 includes ring 73S which engages a corresponding slot 72S in plaster frame 72. Depth adjustment is accomplished through screw teeth 73T engaging attachment flange 74. As screws 73 are turned, moving screws 73 in or out relative to attachment flange 74, rings 73S cause plaster frame 72 to move in or out a corresponding distance.

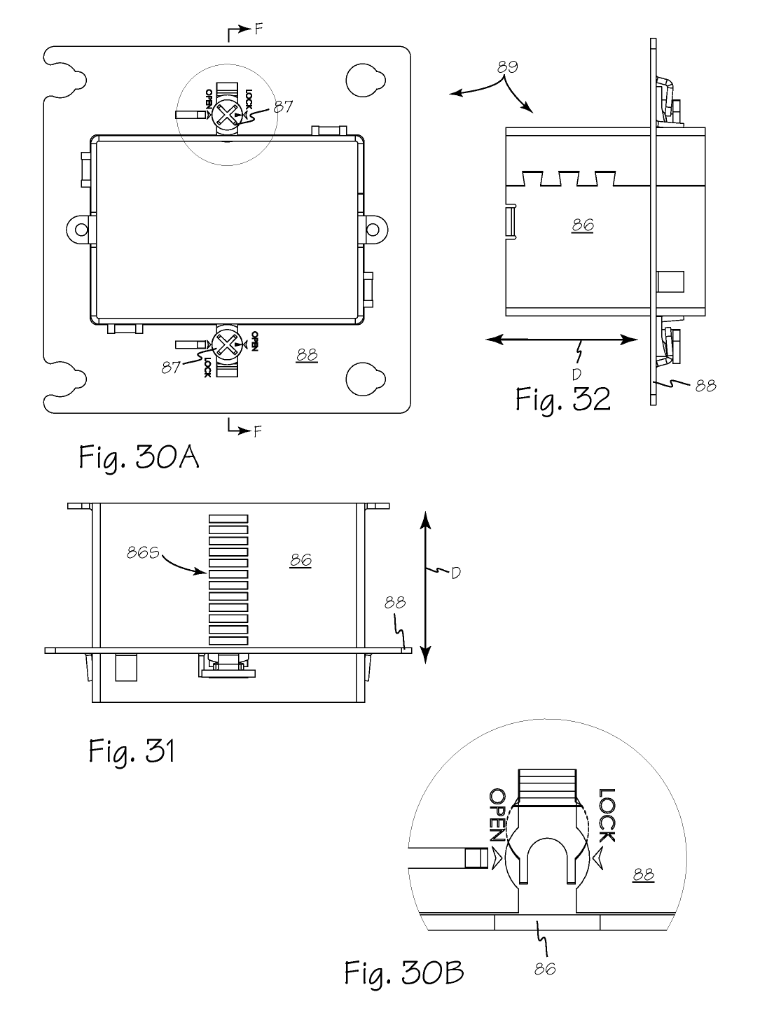

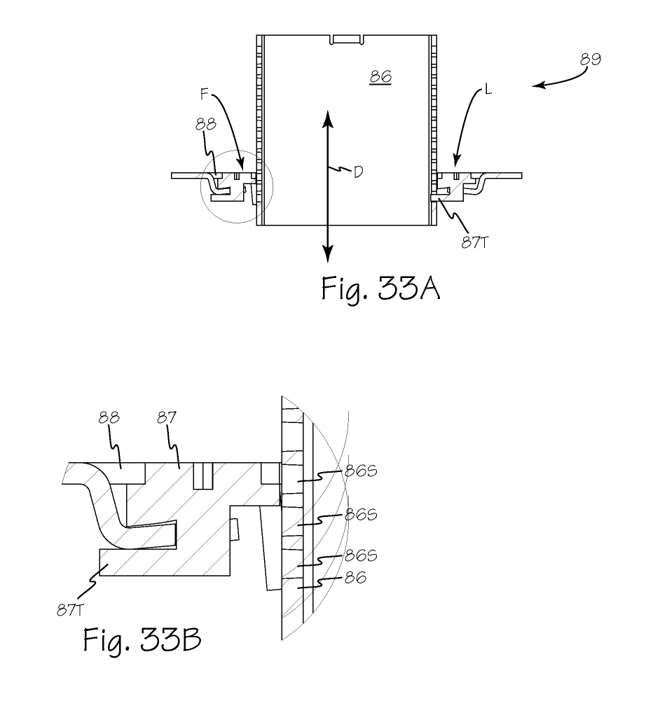

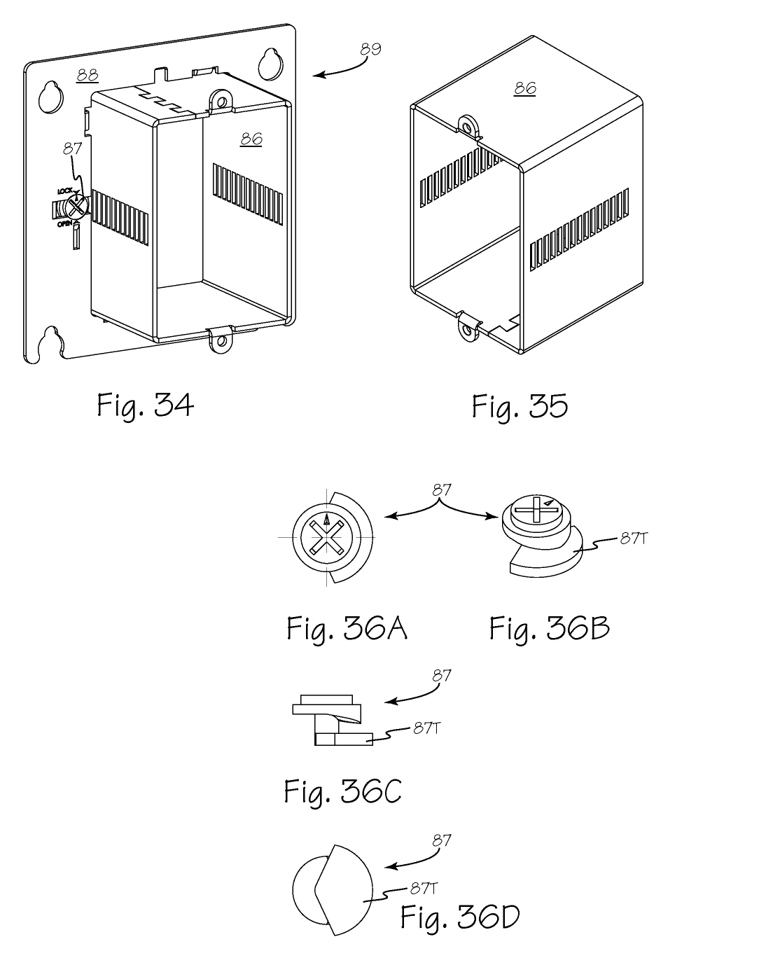

Referring now to FIGS. 30A, 30B, 31, 32, 33A, 33B, 34, 35 and 36A-36D; plaster frame 86 and two or more locking screws such as locking screws 87 and attachment flange 88 are combined to form a depth adjustable plaster ring such as depth adjustable plaster ring 89. Each locking screw 87 includes a locking tooth 87T for engaging at least one of the slots 86S formed in plaster frame 86. In use, each locking screw 87 has a lock and a free orientation. When a screw 87 is in the lock orientation L, screw tooth 87T is engaged with at least one slot 86S. When a screw 87 is in the free orientation F, screw tooth 87T is oriented away from plaster frame 86 and does not engage any element of plaster frame 86. With all screws 87 in free orientation F, plaster frame 86 may be moved along depth axis D relative to attachment flange 88.

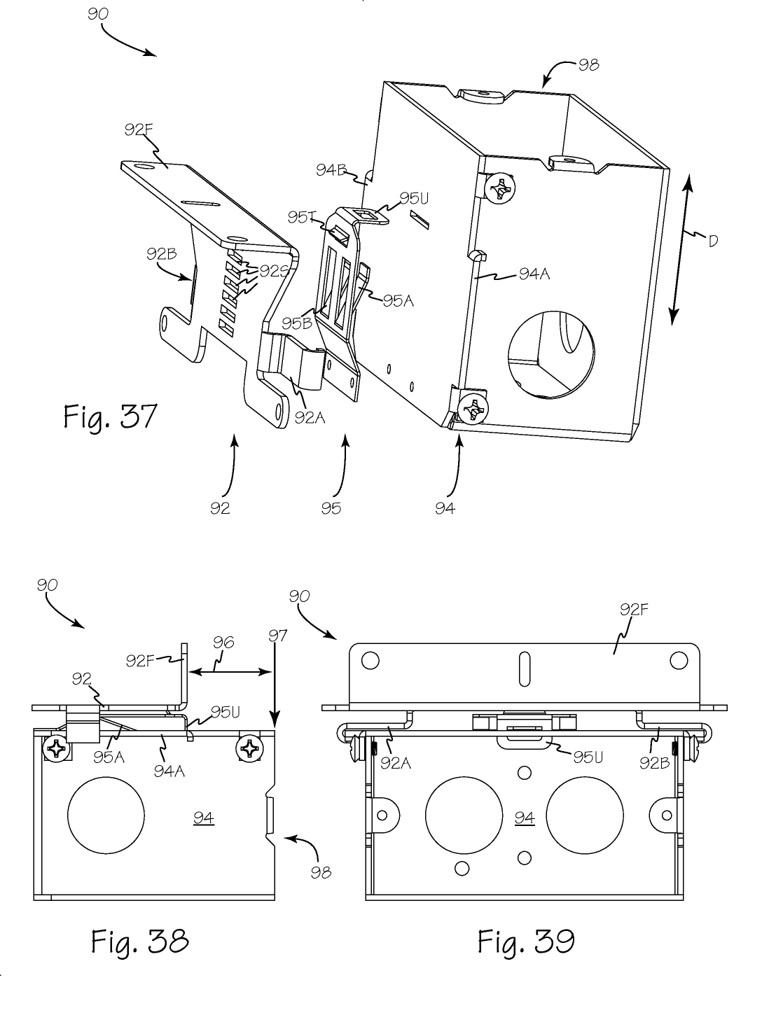

In FIGS. 37, 38 and 39, ratchet bracket electrical box 90 includes slotted locking plate 92 which slidably engages electrical box 94 using any suitable technique such as flanges 94A and 94B engaging plate arms 92A and 92B respectively. Bias spring lock assembly 95 is secured between locking plate 92 and electrical box 94. One or more spring arms such as spring arms 95A and 95B provide biasing resistance to permit locking tab 95T to engage a locking slot such as locking slots 92S. A user may use unlocking tab 95U to overcome the biasing springs and disengage locking tab 95T and thus adjust offset 96 between mounting flange 92F and the plane 97 of electrical box opening 98.

In use, mounting flange 92F of electrical box 90 may be secured to any suitable structural element such as studs, joists, posts, wall panels, gypsum board or other elements. Slotted locking plate 92 may be secured adjacent any suitable opening in a structural diaphragm. Any adjustment that is desired along depth axis D of electrical box 94 relative to the surface of the structural diaphragm may be accomplished through opening 97 by applying force to unlocking tab 95U in opposition the biasing force of spring arms 95A and 95B thus disengaging locking tab 95T from locking slots 12S and changing offset 96.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A depth adjustable electrical box comprising:
an electrical box having at least two opposed sides and at least two opposed ends enclosing a working space;
one or more mounting arms with a plurality of slots, each of the one or mounting arms slidably secured to a side of the electrical box;
a locking arm secured to the electrical box between each mounting arm and the corresponding side of the electrical box, the locking arm including a locking tooth to engage at least one of the plurality of slots with a biasing force.

2. The depth adjustable electrical box of claim 1 wherein the locking arm further comprises:
a spring bias arm providing a bias force against the electrical box.

3. The depth adjustable electrical box of claim 1 wherein the locking arm further comprises:
an offset finger for a user to engage the locking arm.

4. The depth adjustable electrical box of claim 1 wherein the electrical box further comprises a slot in each of the at least two sides, and the locking arm includes an engagement tab extending through the slot into the working space.

5. A depth adjustable electrical box comprising:
an electrical box having at least two opposing sides and at least two opposing ends enclosing a working space, the at least two opposing ends include an adjustment slot for adjusting the depth of the electrical box;
a mounting flange with an opening sized and dimensioned to slidably engage the electrical box;
one or more depth screws engaging the mounting flange, each mounting screw adjacent an opposing end, each screw having a ring engaging the adjustment slot to enable depth adjustment of the electrical box relative to the mounting flange.

6. The depth adjustable electrical box of claim 5 wherein the at least two opposing sides include an adjustment slot for adjusting the depth of the electrical box, and each of the one or more mounting screws is adjacent an opposing side with the ring of the screw engaging the adjustment slot of the side.

7. A depth adjustable plaster ring comprising:
a plaster ring having at least two opposing sides and at least two opposing ends enclosing a working space;
